(19) United States
(12) Patent Application Publication
(10) Pub. No.: US 2024/0375465 A1
(43) Pub. Date: Nov. 14, 2024

(54) VEHICLE TOW HOOK

(71) Applicants: Hyundai Motor Company, Seoul (KR); Kia Corporation, Seoul (KR)

(72) Inventor: Manikandan Babymony, Superior Township, MI (US)

(21) Appl. No.: 18/196,099

(22) Filed: May 11, 2023

(51) Int. Cl. B60D 1/56; B60D 1/04

(52) U.S. Cl. CPC B60D 1/56; B60D 1/04

(57) ABSTRACT

A tow hook system is provided. The tow hook system may comprise a tow hook, comprising a first attachment mechanism configured to secure the tow hook to a bumper beam of a vehicle, and a second attachment mechanism configured to secure the tow hook to a fender apron of the vehicle. The tow hook may be configured to transfer a load from the tow hook to the fender apron.

### BACKGROUND

### Technical Field

Embodiments of the present disclosure relate to vehicle tow hooks and vehicle tow hook systems.

### Background

North American pickup trucks generally have a front tow hook permanently mounted to a front of the vehicle. The tow hook increases the rugged appearance of the vehicle, which is preferred by many North American pickup truck purchasers, regardless of any actual use plans for the tow hook. Additionally, many North American pickup truck purchasers want the tow hook to have the full capability of an actual front tow hook even without the actual need for the front tow hook.

Tow hooks are generally used for towing and recovery under off-road conditions. This equipment is essential for customers who do drive off-road. Usually, a front tow hook is mounted to a bumper beam by a pipe welded to it and it can be temporarily screwed in when in use during recovery, but it is not normally maintained mounted in the bumper. However, pickup truck purchasers generally want the tow hooks to be permanently mounted so as to maintain a rugged appearance of the pickup truck.

Current design construction of tow hooks mounted on pickup trucks may not meet the off-road strength and stiffness requirements needed for the tow hooks. For a unibody platform, an attachment needs to be carefully designed to meet the off-road requirements for the tow hook and, at the same time, not affect the crash performance or deformation mode of the front body structure of the vehicle. It is therefore necessary to design front tow hooks to meet off-road requirements without changes to crash performance or deformation modes of front body structures.

For at least these reasons, a tow hook system that meets strength and stiffness requirements for recovery and towing and, at the same time, maintains crash performance of the front body of the vehicle is needed.

### SUMMARY

According to an object of the present disclosure, a tow hook system is provided. The tow hook system may comprise a tow hook, comprising a first attachment mechanism configured to secure the tow hook to a bumper beam of a vehicle, and a second attachment mechanism configured to secure the tow book to a fender apron of the vehicle The tow hook may be configured to transfer a load from the tow hook to the fender apron.

According to an exemplary embodiment, the first attachment mechanism may comprise a plate.

According to an exemplary embodiment, the tow hook system may comprise a mounting bracket secured to the bumper beam. The first attachment mechanism may be configured to be secured to the mounting bracket.

According to an exemplary embodiment, the tow hook system may comprise a gusset. The second attachment mechanism may be configured to be secured to the gusset. The gusset may be configured to be secured to the fender apron, causing the second attachment mechanism to be secured to the fender apron via the gusset.

According to an exemplary embodiment, the tow hook system may comprise a spacer member positioned between the gusset and the fender apron.

According to an exemplary embodiment, the tow hook may have a laterally offset shape, having a front side and a rear side, configured to enable the tow hook to be secured to the bumper beam and the fender apron.

According to an exemplary embodiment, the first attachment mechanism may be positioned along the front side of the tow hook.

According to an exemplary embodiment, the second attachment mechanism may be positioned along the rear side of the tow hook.

According to an exemplary embodiment, the tow hook may be configured to bend downwardly with an application of a load above a threshold load, causing less than all of the load to be transferred to the fender apron.

According to an object of the present disclosure, a tow hook system is provided. The tow hook system may comprise a vehicle, comprising a bumper plate and a fender apron. The tow hook system may comprise a tow hook, comprising a first attachment mechanism configured to secure the tow hook to the bumper beam, and a second attachment mechanism configured to secure the tow hook to the fender apron. The tow hook may be configured to transfer a load from the tow hook to the fender apron.

According to an exemplary embodiment, the first attachment mechanism may comprise a plate.

According to an exemplary embodiment, the tow hook system may comprise a mounting bracket secured to the bumper beam. The first attachment mechanism may be configured to be secured to the mounting bracket.

According to an exemplary embodiment, the tow hook system may comprise a gusset. The second attachment mechanism may be configured to be secured to the gusset. The gusset may be configured to be secured to the fender apron, causing the second attachment mechanism to be secured to the fender apron via the gusset.

According to an exemplary embodiment, the tow hook system may comprise a spacer member positioned between the gusset and the fender apron.

According to an exemplary embodiment, the tow hook may have a laterally offset shape, having a front side and a rear side, configured to enable the tow hook to be secured to the bumper beam and the fender apron.

According to an exemplary embodiment, the first attachment mechanism may be positioned along the front side of the tow hook.

According to an exemplary embodiment, the second attachment mechanism may be positioned along the rear side of the tow hook.

According to an exemplary embodiment, the tow hook may be configured to bend downwardly with an application of a load above a threshold load, causing less than all of the load to be transferred to the fender apron.

In further aspects, a vehicle is provides that comprises a tow hook as disclosed herein. In certain aspects, suitable vehicles includes SUV and trucks including pickup trucks.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a plurality of tow hook systems mounted to a bumper beam of a vehicle, according to an exemplary embodiment of the present disclosure.

FIG. 2 illustrates a tow hook system mounted to a bumper beam of a vehicle, according to an exemplary embodiment of the present disclosure.

FIG. 3 illustrated an exploded view of a tow hook system according to an exemplary embodiment of the present disclosure.

FIG. 4 illustrates a low speed load transfer path of a side view of a tow hook system mounted to a bumper beam of a vehicle, according to an exemplary embodiment of the present disclosure.

FIG. 5 illustrates a high speed load transfer path of a side view of a tow hook system mounted to a bumper beam of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Generally, rugged vehicles are configured to withstand harsh elements and enable drivers to maneuver through various weather conditions (e.g., snow, deep water, streams, etc.), terrains (e.g., desert, mud, sand, etc.), and activities (e.g., rock climbing, camping, etc.). Front tow hooks are essential equipment to assist rugged vehicles to maneuver through these weather conditions, terrains, and activities and contribute to the ruggedness of vehicle appearance.

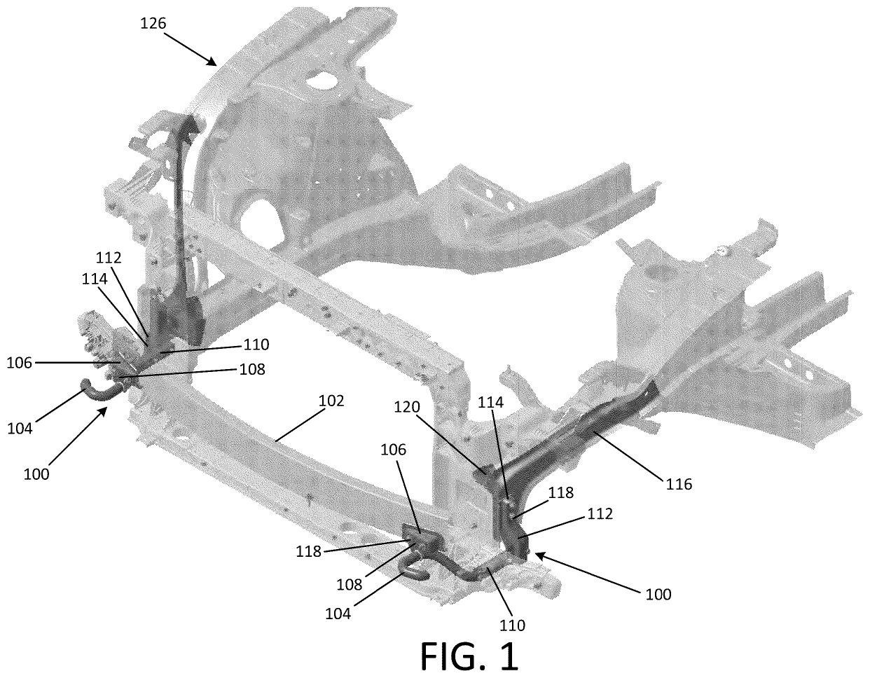

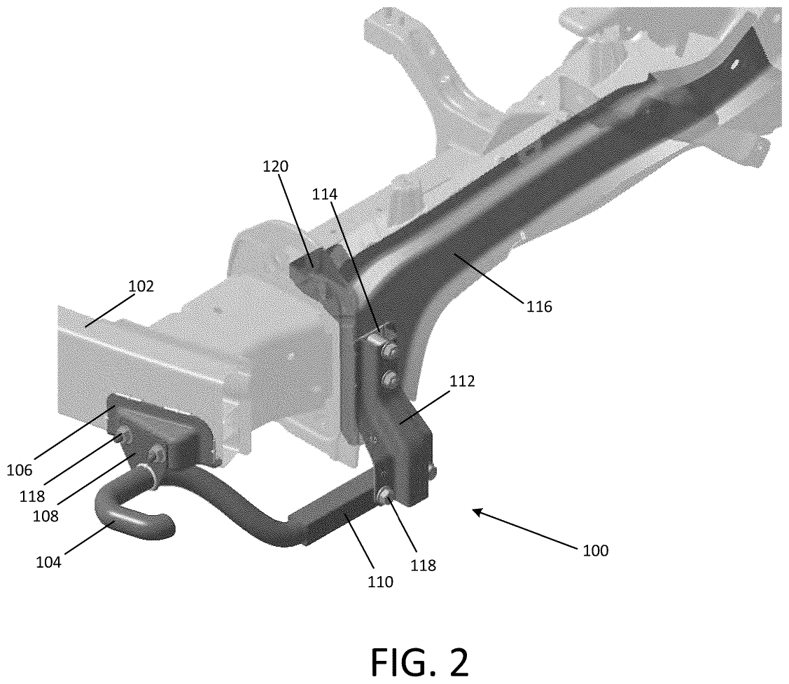

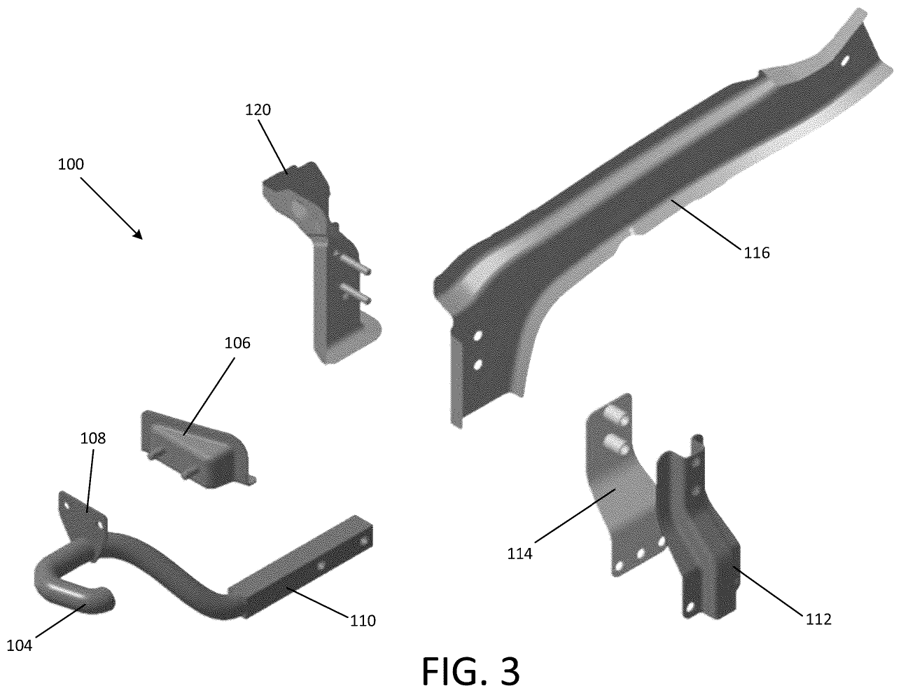

Referring now to FIGS. 1-3, a plurality of tow hook systems 100 mounted to a bumper beam 102 of a vehicle 126 (FIG. 1), a tow hook system 100 mounted to a bumper beam 102 of a vehicle (FIG. 2), and an exploded view of a tow book system 100 (FIG. 3) are illustratively depicted, in accordance with exemplary embodiments of the present disclosure.

According to an exemplary embodiment, the tow hook system 100 may comprise a tow hook 104 (e.g., a front tow hook).

According to an exemplary embodiment, the tow hook 104 may be configured and shaped to mount to the bumper beam 102 of the vehicle via a securing means 106. According to an exemplary embodiment, the securing means 106 may comprise a mounting bracket/plate, as shown in FIGS. 1-3. It is noted, however, that other suitable securing means 106 may be incorporated, while maintaining the spirit and functionality of the present disclosure. According to an exemplary embodiment, the mounting bracket/plate may be welded to the bumper beam 102 and/or other suitable component of the vehicle.

According to an exemplary embodiment, the tow hook 104 may comprise a laterally offset shape. The laterally offset shape may be configured to enable the tow hook 104 to be formed to mount to the bumper beam 102 via a first attachment member (e.g., plate 108 or other suitable component secured to the bumper beam 102 via the securing means 106). According to an exemplary embodiment, the plate 108 may be secured to the securing means 106 via welding, one or more bolts 118, and/or other suitable means.

According to an exemplary embodiment, the tow hook 104 may comprise a second attachment member 110 configured for rear securement of the tow hook system 100 to the vehicle and/or to a securing component (e.g., gusset 112). According to an exemplary embodiment, the tow hook system 100 may comprise a gusset 112. The gusset 112 may be secured to the attachment member 110 on a rear side of the tow hook 104 via bolting, welding, and/or other suitable means According to an exemplary embodiment, the tow hook system 100 may comprise one or more spacers 114 positioned between the gusset 112 and the attachment member 110. According to an exemplary embodiment, the gusset 112 may be configured to secure to a fender apron 116 of the vehicle, via welding, bolting, and/or other suitable securing means, enabling rear mounting of the tow hook system 100 to the vehicle. According to an exemplary embodiment, the tow hook system 100 may comprise an extension member 120 for securing the gusset 112 to the fender apron 116.

According to an exemplary embodiment, the tow hook system 100 is configured to enable a tow function for the vehicle and facilitate a front crash mode for the vehicle.

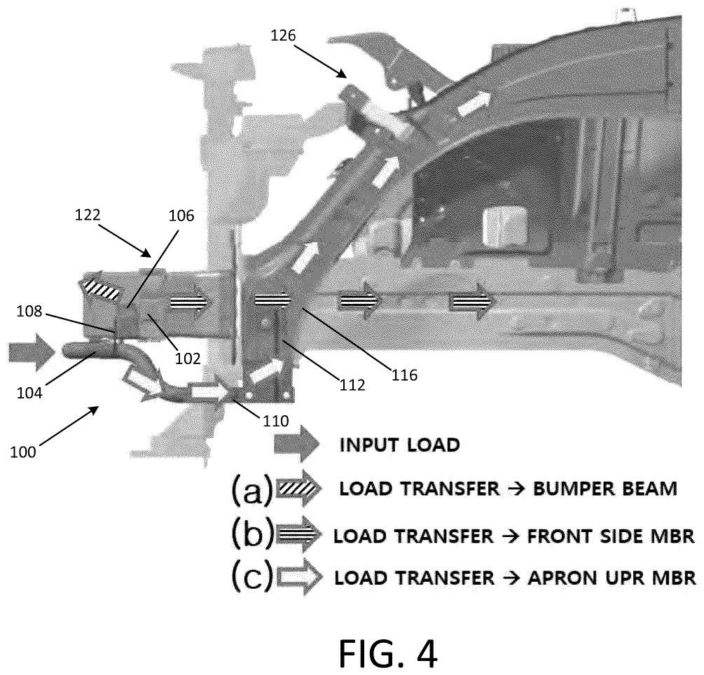

Referring now to FIG. 4, a low speed load transfer path (e.g., during towing, low speed crashes, etc.) of a side view of a tow hook system 100 mounted to a bumper beam 102 of a vehicle 126 is illustratively depicted, in accordance with an exemplary embodiment of the present disclosure.

According to an exemplary embodiment, during loading of the tow hook 104 in a case of recovery and towing (e.g., a towing function), a load, due to tension, compression, and/or slope loading, may get transferred to the bumper beam 102 in an L direction (as shown, e.g., in arrow (a)—Load Transfer→Bumper Beam). According to an exemplary embodiment, the load path may, at the same time, crush a box and front side member of the vehicle 126 in a T direction (as shown, e.g., in arrow (b)—Load Transfer→Front Side Mbr), causing the input load to displace the vehicle 126 rearwardly, and/or, at the same time, move angularly upward by the fender apron 116 (as shown, e.g., in arrow (c)—Load Transfer→Apron Upr Mbr), causing relatively no deformation of the tow hook 104 from the input load.

During a low speed front crash mode, without a tow hook 104, a front side member 122 of the vehicle 126 and the fender apron 116 may be configured and designed to bend and/or deform in a certain way so as to absorb the energy in a best possible way. According to an exemplary embodiment, the tow hook system 100 of the present disclosure may be configured, in a low speed frontal crash, to transfer the input load angularly upward by the fender apron 116 (as shown, e.g., in arrow (c)—Load Transfer→Apron Upr Mbr), causing relatively no deformation of the tow hook 104 from the input load. According to an exemplary embodiment, during a low speed frontal crash, the tow hook system 100 may be configured to transfer the input load in a direction to crush a box and front side member of the vehicle 126 in a T direction (as shown, e.g., in arrow (b)—Load Transfer→Front Side Mbr), causing the input load to displace the vehicle 126 rearwardly.

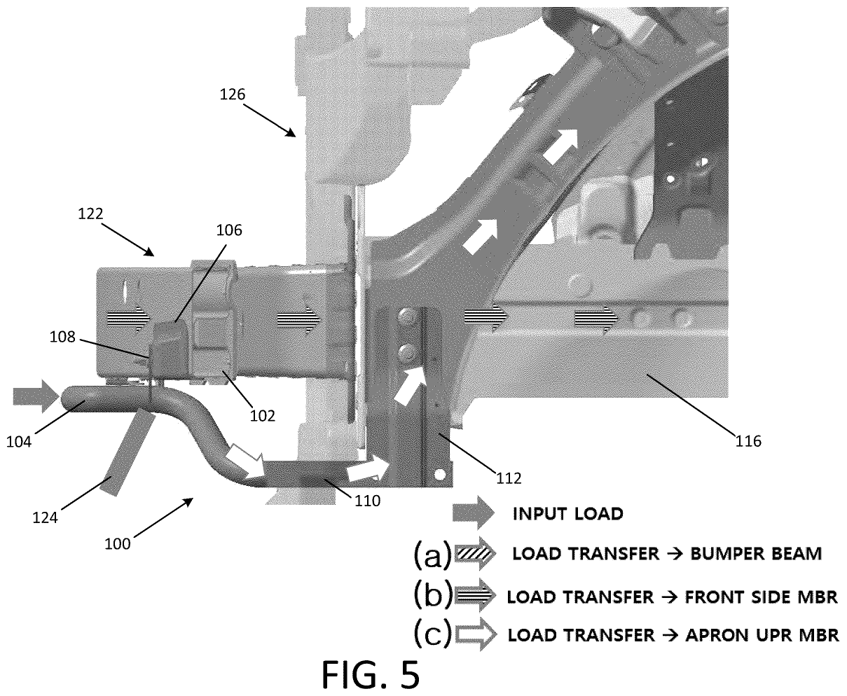

Referring now to FIG. 5, a high speed load transfer path (e.g., during high speed crashes, etc.) of a side view of a tow hook system 100 mounted to a bumper beam 102 of a vehicle 126 is illustratively depicted, in accordance with an exemplary embodiment of the present disclosure.

According to an exemplary embodiment, as shown in FIG. 5, during a high speed crash, the tow hook 104 may be configured to initially act to transfer the input load angularly upward by the fender apron 116 (as shown, e.g., in arrow (c)—Load Transfer→Apron Upr Mbr), but, after the input load reaches a threshold high load, the tow hook 104 may bend downwards (e.g., towards position 124, as shown in FIG. 5).

According to an exemplary embodiment, the bent down tow hook 104 may be configured to act as a connection between the bumper beam 102, the front side member 122, and the fender apron 116.

According to an exemplary embodiment, the bending of the front tow hook 104 enables not all of the input load to be transferred to the fender apron 116, once a threshold input load has been reached, as an excessive load transfer to the fender apron 116 may result in an excessive intrusion into the cabin of the vehicle 126.

According to an exemplary embodiment, the bending of the front tow hook 104 may result in a second peak in a deceleration pulse to be achieved, resulting in no change to a front side member 122 deformation mode, enabling the front side member 122 to bend and absorb energy during all of a frontal high speed crash mode. Accordingly, according to an exemplary embodiment, the tow hook system 100 may be configured to cause front side member 122 deformation to not be effected due to the presence or absence of the front tow hook 104. According to an exemplary embodiment, after the front tow hook 104 is bent, the complete front body of the vehicle 126 (e.g., the bumper beam 102, the front side member 122, and the fender apron 116) may be configured to work together for optimum absorption and transfer of the crash energy.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A tow hook system, comprising:
a tow hook, comprising:
a first attachment mechanism configured to secure the tow hook to a bumper beam of a vehicle; and
a second attachment mechanism configured to secure the tow hook to a fender apron of the vehicle,
wherein the tow hook is configured to transfer a load from the tow hook to the fender apron.

2. The tow hook system of claim 1, wherein the first attachment mechanism comprises a plate.

3. The tow hook system of claim 1, further comprising a mounting bracket secured to the bumper beam,
wherein the first attachment mechanism is configured to be secured to the mounting bracket.

4. The tow hook system of claim 1, further comprising a gusset,
wherein:
the second attachment mechanism is configured to be secured to the gusset, and
the gusset is configured to be secured to the fender apron, causing the second attachment mechanism to be secured to the fender apron via the gusset.

5. The tow hook system of claim 4, further comprising a spacer member positioned between the gusset and the fender apron.

6. The tow hook system of claim 1, wherein the tow hook has a laterally offset shape, having a front side and a rear side, configured to enable the tow hook to be secured to the bumper beam and the fender apron.

7. The tow hook system of claim 6, wherein:
the first attachment mechanism is positioned along the front side of the tow hook, and
the second attachment mechanism is positioned along the rear side of the tow hook.

8. The tow hook system of claim 1, wherein the tow hook is configured to bend downwardly with an application of a load above a threshold load, causing less than all of the load to be transferred to the fender apron.

9. A tow hook system, comprising:
a vehicle, comprising:
a bumper plate; and
a fender apron; and
a tow hook, comprising:
a first attachment mechanism configured to secure the tow hook to the bumper beam; and
a second attachment mechanism configured to secure the tow hook to the fender apron,
wherein the tow hook is configured to transfer a load from the tow hook to the fender apron.

10. The tow hook system of claim 9, wherein the first attachment mechanism comprises a plate.

11. The tow hook system of claim 9, further comprising a mounting bracket secured to the bumper beam,
wherein the first attachment mechanism is configured to be secured to the mounting bracket.

12. The tow hook system of claim 9, further comprising a gusset,
wherein:
the second attachment mechanism is configured to be secured to the gusset, and
the gusset is configured to be secured to the fender apron, causing the second attachment mechanism to be secured to the fender apron via the gusset.

13. The tow hook system of claim 12, further comprising a spacer member positioned between the gusset and the fender apron.

14. The tow hook system of claim 9, wherein the tow hook has a laterally offset shape, having a front side and a rear side, configured to enable the tow hook to be secured to the bumper beam and the fender apron.

15. The tow hook system of claim 14, wherein:
the first attachment mechanism is positioned along the front side of the tow hook, and the second attachment mechanism is positioned along the rear side of the tow hook.

16. The tow hook system of claim 9, wherein the tow hook is configured to bend downwardly with an application of a load above a threshold load, causing less than all of the load to be transferred to the fender apron.

17. A vehicle comprising a tow hook system of claim 1.
